(19) United States
(12) Patent Application Publication
(10) Pub. No.: US 2014/0372303 A1
(43) Pub. Date: Dec. 18, 2014

(54) Online Authentication and Payment Service

(71) Applicant: Oren Gafni, Tel-Aviv (IL)

(72) Inventor: Oren Gafni, Tel-Aviv (IL)

(21) Appl. No.: 13/919,008

(22) Filed: Jun. 17, 2013

(51) Int. Cl. G06Q 20/40

(52) U.S. Cl. CPC G06Q 20/40
USPC 705/44

(57) ABSTRACT

System and methods of authentication and payment service, comprising an authentication server and a mobile device application. Using this service, a third-party website can utilize a secure and comfortable user sign-in and payment process. Once a user is registered to the service, he can use it to securely and comfortably sign-up, sign-in or make payments to any website which utilizes the service.

### BACKGROUND

The vast majority of existing websites which implement a user authentication & verification process do so as a part of the website's own code and mechanism. A new user, visiting such a website for the first time, is required to register by going through a process designed for that specific purpose (sign up). This process includes the user filling in his personal details, coming up with a unique user identifier for future identity recognition and setting up an associated password, made of a sequence of letters, numbers and symbols, supposedly known only to the user himself. These credentials are stored along with other user details in the website's database. The next time the user wishes to access the website, he is required to fill in, by going through another designated process (sign in), the same identifier and password as were defined in the registration process. At this stage, the website matches these credentials with those that are stored in the website's database and verifies that they are indeed consistent. Should the website find them to be matching, it will enable the user access to whatever services or information the process was meant to protect. The described method is vulnerable to a great variety of security risks, reliability problems and user discomfort. In order to implement this method in a reliable and secure manner, the website owner must invest a great amount of resources and effort in developing the mechanism, while utilizing different technologies and tools designated to provide solutions to the different security issues involved. Many websites avoid making these investments and so their authentication process suffers from a low level of security and is vulnerable to many potential risks.

Other tools and mechanisms aiming to provide a solution to the security issues of the common “username-password” authentication method require greater investments yet, on both the website owners' and the users' part. These solutions are usually limited to a specific website or security measure and fail to provide the user a comprehensive solution with access to other websites.

To the average user, who is required to register to an ever-increasing number of websites, the “username-password” authentication method sets a series of issues which lead to unreasonable difficulties. In order to provide decent security, the user is required to set up and remember long, intricate passwords which include numbers, letters and symbols and that are hard to guess but easy to remember, else he will lose access to the website and will be forced to go through an exhausting process of password recovery. The user is required to use a different password in each website and change each password periodically. Because these demands are unreasonable, most users tend to pick one relatively short and simple password which includes information that can be easily remembered (and guessed) such as a telephone number or a birth-date and use that same password for most websites. As a result of that, not only does the system make it hard on the user to manage his access to all websites, it also severely compromises the level of security, potentially allowing malicious parties to hack into websites, impersonate the user, perform data sabotage, frauds and information theft in an ever increasing scale.

To a new website developer, making use of the “username-password” method is the easiest and most inexpensive way to handle user authentication & verification. In addition, since the use of passwords is a universal consensus accepted everywhere, there is no alleged reason to stop using it. This approach creates an overgrowing problem and requires a fundamental solution.

Many websites accept payments for products and services online. Feeding in payment method details on the web is extremely risky. Firstly, these sensitive details may be exposed to malware while entered. Secondly, in many cases the data is stored in the website's database which often maintains a low level of security and is therefore vulnerable to hacking, even long after the purchase has been made. The more we expose the payment details to an ever growing number of websites, the higher the risk of these reaching the hands of a malicious factor.

### SUMMARY

The idea underlying the proposed method is to remove the entire process of user registration, authentication and payment from the hands of websites and pass it on to an external third party service provider, who will execute the process in a professional, secure and convenient manner. The service is provided to all websites in a way that saves them the investment required to develop the entire mechanism themselves and also significantly improves the level of security and service for the users. The service provides the user the possibility to register just once and use a homogeneous system in order to access all websites. Intrinsically, this service provides a higher level of security, greater convenience and a cost-effective, easy to implement solution for website developers.

Unlike other solutions, the proposed method does not define how the website is to implement the solution within its own mechanism. It requires the website to implement only the interface to the authentication and payment service provider. The website trusts the service provider that the handling of these subjects is done professionally, thoroughly and in a secure manner and relies on the authentication provided to him by the service provider to enable the user access to any services and information needed.

When a new unknown user turns to a website, the website may turn to the service provider and receive through him, conditioned by the user's approval, all the details and information required in order to register the user and store his details in the website's database. The user may feed these details once as he registers to the authentication service for the first time and will not be required to feed them again as he attempts to access new websites. Even as some details may change over time, the user can update them once using the service and those will be updated (conditioned by the users approval) in every website without the need of re-feeding them in each website separately.

As an additional service to users and website owners, the proposed method includes also a mechanism that enables secure and safe payment clearance. By employing this mechanism, the user can securely enter his payment method information to the system, using an application installed on his mobile device just once. Following that, the user can pay on any website which implements the service, without having to re-enter the payment method details or exposing it to the payment receiver. The payment authorization is done through the user's mobile device to prevent any attempts of phishing, fraud and information theft.

### BRIEF DESCRIPTION OF THE DRAWINGS

FIG. 1 depicts in a schematic diagram the manner in which the various factors participating in the proposed process are related.

FIG. 2 depicts in a schematic diagram the various components of the proposed method and provides also an example of the authentication & verification process of a user registered to the authentication service, while accessing a website that had implemented use of the service.

FIG. 3 depicts in a flowchart an example of the stages taking place during an authentication & verification process of a user registered to the authentication service while accessing a website that had implemented use of the service and identifies the user.

FIG. 4 depicts in a flowchart an example to the stages taking place during the payment process.

### DETAILED DESCRIPTION OF THE DRAWINGS

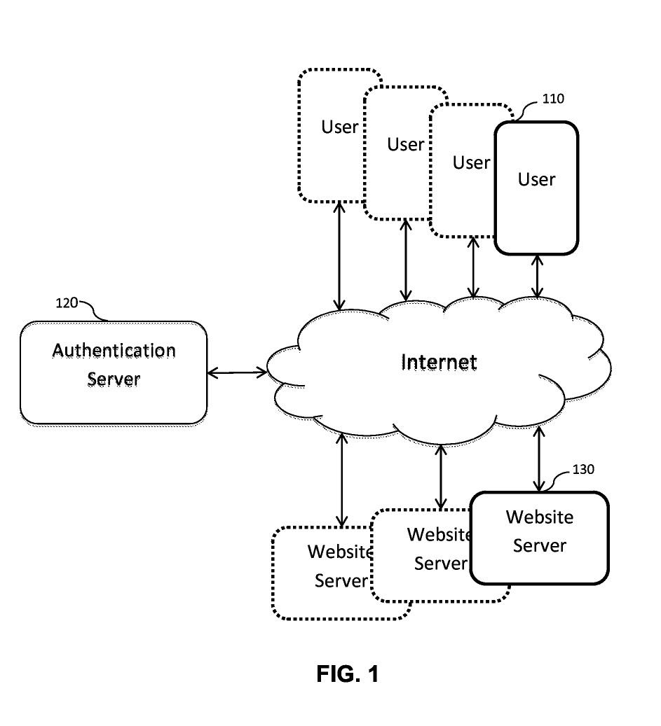

FIG. 1 describes in a general manner the factors participating in the proposed process and the way in which they are related to one another. The user 110 is the factor registering to the authentication service by installing a designated application on his mobile device, which communicates safely over the internet with the authentication server 120. The website server 130 is a system belonging to a third party factor registering to the authentication service, which communicates safely over the internet with the authentication server 120.

Once both the user and the website server are registered to the service on the authentication server, the user 110 can activate the website 130 on any computer and identify himself via the authentication server 120. In cases when the website 130 is not familiar with the user 110, it will turn to the authentication server 120 and request additional details required for the registration of the user. This request is then forwarded by the authentication server to the user 110, through the application installed on his mobile device, requesting him to approve sharing of the details. Once approved, the authentication server 120 will reply and send the required details back to the website 130.

When the website enables online payments and has the process, proposed by the service implemented, the user 110 can order the website to charge his account using the service. The website 130 sends a request, including the payment details, to the authentication server 120 which transfers it to the users mobile device 110 for approval. Once approved, the authentication server 120 charges the user's account using the details entered by the user during his preliminary registration to the service. After completing this step, the authentication server 120 notifies the website 130 that the payment has been made and the website displays the details for the user.

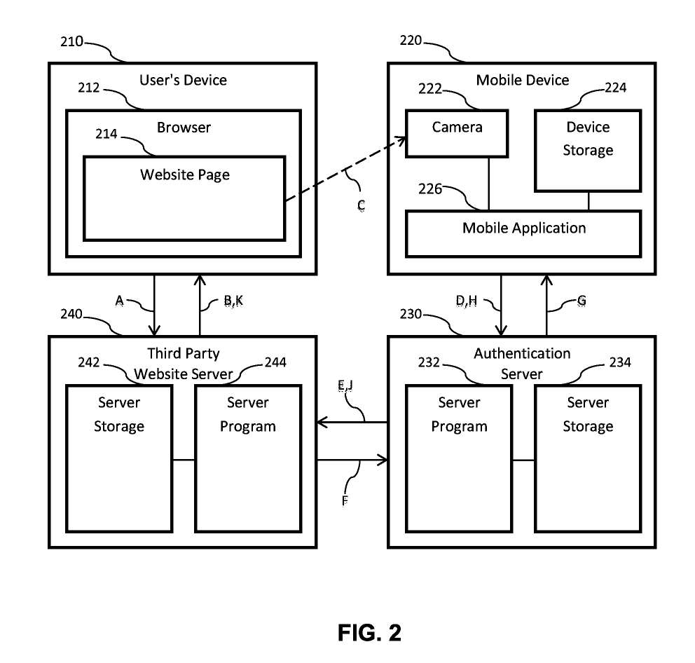

FIG. 2 describes in a general manner the components comprising the proposed method and demonstrates the steps of the authentication & verification process in which a user interacts with a website as he accesses it using the service.

The user activates a browser 212 on his computer 210 and accesses a third party's website server 240 that operates the website's program 244, by sending request A. The program produces a graphical image of a QR code (which contains identification data of the website in a format predefined by the service) and integrates the image on the website's entry page 214 that is sent back as response B to be displayed in the browser 212. In action C, the user scans the displayed QR code image using the mobile device's camera 222 and the authentication service application 226, which he had installed on his mobile device 220. The application decrypts and verifies the data received from the QR code and uses the definitions stored in the device's memory 224 to send the data D over to the authentication server 230 which operates the servers program 232.

The authentication servers program verifies the user and the website's data using its database 234 and sends a message E (which contains the website's and the users details in a format predefined by the service) to the third party's website server 240. The website's server program 244 compares the details with the data on its database 242 and when required, sends a request F to the authentication server 230 for approval and for any additional data.

In case approval is required, the authentication server sends a request G to the application 226 requesting the users approval. Once approved by the user, the application sends the approval H back to the authentication server 230, which will send the response J to the website's server 240. The website's program 244 updates the details in the website's database 242 and performs action K to enable the user the required access.

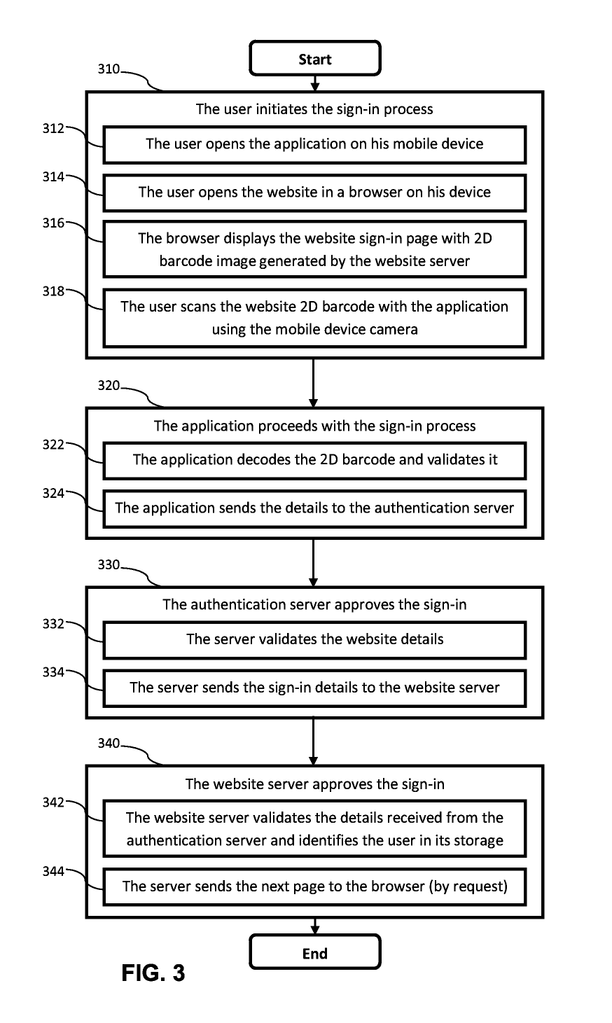

FIG. 3 describes in a general manner the workflow and the different stages of the authentication & verification process, performed by a user registered to the service and a website which has the service implemented under the proposed method.

At the first stage 310 the user initiates the entry process to a website. The process begins by activating 312 the application of the authentication service installed on a mobile device owned by the user. The application is protected by one short pass-code defined by the user in order to prevent anyone else from using it, in case the mobile device it is installed on is stolen or lost. By activating the application, an automated registration process to the authentication server is launched. This process is to insure secured communication between the authentication server and the application, using an encrypted protocol while identifying and verifying both factors. In addition, before or after action 312, the user activates 314 the third party's website in a browser installed in any computer. The manner and process in which the website is activated is entirely up to the website's owner and is not directly related to the proposed method. At some point, the browser displays 316 the website's entry page on the screen, as received from the website's server. This page contains, among other details, a graphical image of a QR code generated by the website's server. The image contains the date of its creation, the website's identification code in the authentication server and the website's process identification code, in an encrypted manner, using a predefined structure designed by the service. The user scans 318 the QR code image displayed on the screen using the application installed on his device and the device's camera. The scanning is performed automatically by turning the camera towards the QR code image displayed on the screen and without requiring any additional actions from the user.

At the second stage 320 the application continues the sign-in process to the website. The application decrypts and verifies 322 the data from the QR code image. Among other things, the structure of the data is tested to verify consistency with the authentication service's protocol and the QR code date is confirmed to be recent (an old QR code date will force the user to refresh the entry screen and repeat the scan). Following that, the application sends 324 the data to the authentication server, over a secure, encrypted channel created between the application and the authentication server during the activation of the application.

At the third stage 330, the authentication server executes a process where it verifies and approves the users access. The process includes comparing and verifying 332 the website's details with the list of websites registered to the service on the authentication server's internal database. Following this test the authentication details are sent 334 to the website's server. Included in the details are the website's session identification code and the users identification code, organized in a structure according to the service's protocol. The details are sent over a secure, encrypted channel between the website and the authentication server created proactively by the website's server or after sending a request from the authentication server to the website's server.

At the last stage 340, the website's server completes the authentication process. This action and the manner in which it is implemented are entirely up to the website's owner and is not related directly to the proposed method. The website's server verifies 342 the details and locates the users definitions in its database. According to these definitions the website's server enables the user access and displays 344 the next stage for the user's process in the website. The website's owner may implement a process through which he can turn to the authentication server in order to request additional details regarding the user, in case of a new user registration, or update existing details. This is conditioned by the users approval, given via the application on his mobile device.

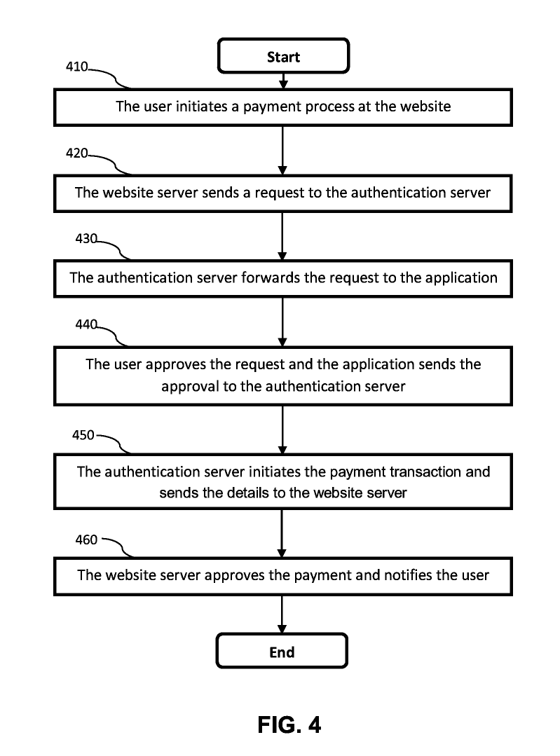

FIG. 4 describes in a general manner the workflow and the different stages of the payment process implemented by using the authentication server under the proposed method.

At the first stage 410 the user initiates the payment process on a third party website. The whole process up to the point of payment is performed by the website and is under its responsibility.

When the user confirms the payment on the website, the website contacts the authentication server with a request 420. This request contains the website's ID, the users ID and the payment's details and amount. The website can set fixed beneficiary details during the registration process to the service or transfer the beneficiary details when sending the request. This request is carried out under a predefined protocol determined by the service, using a secure communication channel between the two servers.

The authentication server contacts the application installed on the users mobile device with a request 430 and forwards the payment details to it on a secure communication channel.

The application presents the details to the user and requests his approval for the payment. The payment approval is given by entering a short PIN code defined by the user during his registration to the service. After approving the payment, the application sends the users approval 440 to the authentication server. The approval includes a one-time password based on the short PIN entered by the user.

The server compares and verifies the one-time password with data recorded in the user's entry in its database and carries out the payment order 450 using the clearance services, according to the payment method details entered by the user during his registration to the service and the beneficiary details set by the website. After carrying out the payment order, the authentication server notifies both the application and the website's server that the payment has been made. This report is carried out under a predefined protocol determined by the service and which contains the users details, the payment details and a reference number of the actual payment transaction.

Having received the report, the website's server authorizes the payment in its database and notifies 460 the user about the completion of the process. This process is performed by the website and is under its responsibility.

1. A method, comprising:
enabling a third-party website to register for the authentication service and utilize the sign-up, sign-in and payment protocols;
enabling a user to install the authentication service application on his mobile device and to register for the authentication service;
enabling a registered user to sign-up, sign-in or make payments for any registered third-party website.

2. A system, comprising:
mobile device application that, when installed and executed on the mobile device, performs a method comprising:
enabling a user to register for the authentication service;
signing-in for the service to the authentication server;
capturing the barcode image with the mobile device camera;
decoding the barcode image and decrypting the third-party server credentials;
transmitting the third-party server credentials to the authentication server;
receiving requests from the authentication server to be approved by the user;
transmitting the user approval or denial to the authentication server;
one or more servers; and
authentication server program that, when executed by a server, performs a method comprising:
enabling a third-party website to register for the authentication service;
enabling a user to register for the authentication service;
enabling the mobile application to sign-in for the authentication service;
enabling the mobile application to send requests of sign-in for third-party websites;
transmitting the user identification to a third-party website;
receiving request from a third-party website to be approved by the user;
transmitting the approval request to the mobile application;
receiving the user approval or denial from the mobile application;
transmitting the user approval or denial to the third-party website;
transmitting additional user details to a third-party website;
initiating payment transaction on request from a third-party website after the users approval has been received from the mobile application.
